(19) United States
(12) Patent Application Publication
(10) Pub. No.: US 2017/0173517 A1
(43) Pub. Date: Jun. 22, 2017

(54) APPARATUS AND METHOD FOR CAPTURING TARGET COMPONENT FROM GAS

(71) Applicant: National Tsing Hua University, Hsinchu City (TW)

(72) Inventors: David S. H. Wong, Hsinchu City (TW); Matthias Thiel, Hsinchu City (TW); Cheng-Hsiu Yu, Hsinchu City (TW); Jia-Lin Kang, Hsinchu City (TW); Shi-Shang Jang, Hsinchu City (TW)

(21) Appl. No.: 15/071,220

(22) Filed: Mar. 16, 2016

(30) Foreign Application Priority Data
Dec. 17, 2015 (TW) 104142417

(51) Int. Cl. B01D 53/14

(52) U.S. Cl. CPC B01D 53/1425; B01D 53/1475; B01D 53/1406; B01D 2252/20

(57) ABSTRACT

Provided is an apparatus for capturing a target component from a gas including a rotating packed bed and a packed bed. The rotating packed bed has a first absorbent inlet, a first absorbent outlet, a first gas inlet and a first gas outlet. The packed bed has a second absorbent inlet, a second absorbent outlet, a second gas inlet and a second gas outlet. The first absorbent outlet is in connection with the second absorbent inlet to form an absorbent flow path that sequentially passes through the rotating packed bed and the packed bed. The second gas outlet is in connection with the first gas inlet to form a gas flow path that sequentially passes through the packed bed and the rotating packed bed.

### CROSS-REFERENCE TO RELATED APPLICATION

This application claims the priority benefit of Taiwan application serial no. 104142417, filed on Dec. 17, 2015. The entirety of the above-mentioned patent application is hereby incorporated by reference herein and made a part of this specification.

### BACKGROUND OF THE INVENTION

Field of Invention

The present invention is related to an apparatus and a method for capturing a target component from a gas, and more generally to an apparatus and a method for capturing a target component from a gas by simultaneously using a packed bed and a rotating packed bed.

Description of Related Art

Fossil fuel and carbon-intensive industry plays the leading role in economic development, but a great amount of greenhouse gas such as carbon dioxide or the like is generated. In order to meet the global trend and target to reduce the greenhouse gas generation and carbon emission, the research and development for capturing the greenhouse gas is imperative under the situation.

Currently, chemical absorption is the most popular method for capturing the greenhouse gas. Two common capturing techniques include a technique using a packed bed (PB) and another technique using a rotating packed bed (RPB).

However, the gas-liquid mass transfer efficiency limitations of the packed bed lead large equipment size and high equipment cost. On the other hand, although the gas-liquid mass transfer efficiency improvement and the equipment volume reduction are achieved in the technique using a rotating packed bed, another problem arises from the high energy consumption.

### SUMMARY OF THE INVENTION

The present invention provides an apparatus and a method for capturing a target component from a gas, in which the volume of the capturing apparatus can be effectively decreased and the energy consumption for capturing the target component can be greatly reduced.

The present invention provides an apparatus for capturing a target component from a gas including a rotating packed bed and a packed bed. The rotating packed bed has a first absorbent inlet, a first absorbent outlet, a first gas inlet and a first gas outlet. The packed bed has a second absorbent inlet, a second absorbent outlet, a second gas inlet and a second gas outlet. The first absorbent outlet is in connection with the second absorbent inlet to form an absorbent flow path that sequentially passes through the rotating packed bed and the packed bed. The second gas outlet is in connection with the first gas inlet to form a gas flow path that sequentially passes through the packed bed and the rotating packed bed.

According to an embodiment of the present invention, the apparatus further includes an absorbent pipeline system, and the first absorbent outlet is in connection with the second absorbent inlet via the absorbent pipeline system.

According to an embodiment of the present invention, the apparatus further includes a gas pipeline system, and the second gas outlet is in connection with the first gas inlet via the gas pipeline system.

According to an embodiment of the present invention, the apparatus further includes an absorbent supply apparatus in connection with the first absorbent inlet and configured to supply an absorbent to the rotating packed bed.

According to an embodiment of the present invention, the apparatus further includes a gas source in connection with the second gas inlet and configured to supply a gas to be treated to the packed bed.

According to an embodiment of the present invention, the apparatus further includes an absorbent regenerating apparatus having a third absorbent inlet and a third absorbent outlet, and the third absorbent inlet is in connection with the second absorbent outlet.

According to an embodiment of the present invention, the absorbent regenerating apparatus includes a stripper.

According to an embodiment of the present invention, the apparatus further includes a target component purification apparatus in connection with the absorbent regenerating apparatus.

According to an embodiment of the present invention, the rotating packed bed includes a high-gravity rotating packed bed.

According to an embodiment of the present invention, a rotating speed of the rotating packed bed is 100 rpm to 3,000 rpm, for example.

According to an embodiment of the present invention, the rotating speed of the rotating packed bed is 700 rpm to 1,600 rpm, for example.

According to an embodiment of the present invention, the target component includes carbon dioxide.

The present invention further provides a method for capturing a target component from a gas including the following steps. A rotating packed bed and a packed bed that are in connection with each other are provided. An absorbent is sequentially passed through the rotating packed bed and the packed bed. A gas to be treated is sequentially passed through the packed bed and the rotating packed bed. The absorbent and the gas to be treated are in contact with each other in the rotating packed bed and in the packed bed, so that a target component of the gas to be treated is captured by the absorbent.

According to an embodiment of the present invention, the method further includes using an absorbent regenerating apparatus to remove at least a portion of the target component captured by the absorbent.

According to an embodiment of the present invention, the method further includes using a target component purification apparatus to purify the target component from the absorbent regenerating apparatus.

According to an embodiment of the present invention, a rotating speed of the rotating packed bed is 100 rpm to 3,000 rpm, for example.

According to an embodiment of the present invention, the rotating speed of the rotating packed bed is 700 rpm to 1,600 rpm, for example.

According to an embodiment of the present invention, the target component includes carbon dioxide.

According to an embodiment of the present invention, the absorbent includes monoethanolamine (MEA), piperazine anhydrous (PZ), 2-(diethylamino)ethanol (DEEA) or a combination thereof.

According to an embodiment of the present invention, a concentration of the absorbent is 10 wt % to 30 wt %, for example.

In the above mention, the present invention provides an apparatus and a method for capturing a target component from a gas, in which an absorbent sequentially passes through a rotating packed bed and a packed bed, and a gas to be treated sequentially passes through the packed bed and the rotating packed bed. By such configuration, the capturing efficiency of the target component is significantly improved, the volume of the capturing apparatus is greatly decreased, and the energy consumption for capturing the target component is effectively reduced. Therefore, the equipment cost and energy cost are accordingly reduced.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an apparatus for capturing a target component from a gas according to an embodiment of the present invention.

FIG. 2 is a process flow of capturing a target component from a gas according to an embodiment of the present invention.

FIG. 3 is a volume comparison chart of a capturing apparatus using a rotating packed bed in combination with a packed bed according to an embodiment of the present invention, a conventional capturing apparatus using a packed bed alone, and another conventional capturing apparatus using a rotating packed bed alone.

FIG. 4 is an energy consumption comparison chart of a capturing apparatus using a rotating packed bed in combination with a packed bed according to an embodiment of the present invention and a conventional capturing apparatus using a rotating packed bed alone.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

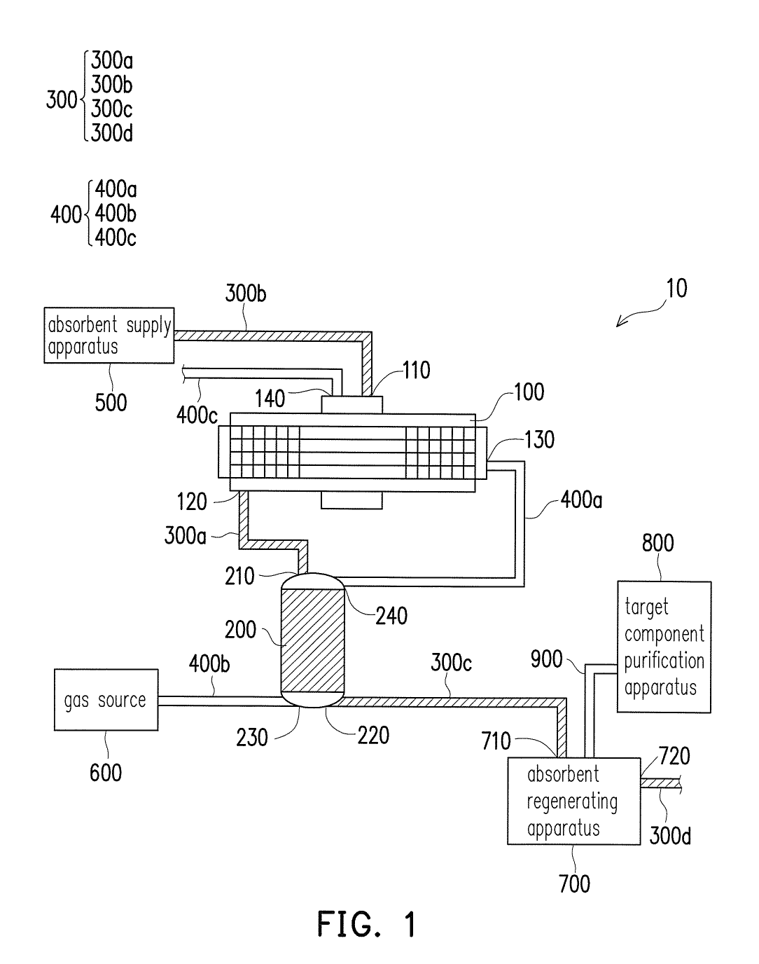

FIG. 1 is an apparatus for capturing a target component from a gas according to an embodiment of the present invention.

Referring to FIG. 1, an apparatus 10 for capturing a target component from a gas (or called “capturing apparatus 10” hereinafter) includes a rotating packed bed 100 and a packed bed 200. The capturing apparatus 10 can capture a target component from a gas to be treated by an absorbent. The gas to be treated can be, for example, a flue gas of power plants, steel mills or oil refineries. The target component can be carbon dioxide, for example.

The rotating packed bed 100 has an absorbent inlet 110, an absorbent outlet 120, a gas inlet 130 and a gas outlet 140. The rotating packed bed 100 can be a high-gravity rotating packed bed, for example. In an embodiment, the rotating packed bed 100 has a rotating speed of 100 rpm to 3,000 rpm, for example. In another embodiment, the rotating packed bed 100 has a rotating speed of 700 rpm to 1,600 rpm, for example.

The flow patterns/directions of an absorbent and a gas to be treated in the rotating packed bed 100 are provided below for illustration purposes, and are not construed as limiting the present invention. For example, the absorbent flows into the rotating packed bed 100 from the absorbent inlet 110 at the top of the rotating packed bed 100, and flows out of the rotating packed bed 100 from the absorbent outlet 120 at the bottom of the rotating packed bed 100. The gas to be treated flows into the rotating packed bed 100 from the gas inlet 130 at one side of the rotating packed bed 100, and flows out of the rotating packed bed 100 from the gas outlet 140 at the top of the rotating packed bed 100. By such manner, the flow direction of the absorbent is opposite to the flow direction of the gas to be treated.

The rotating packed bed 100 is rotated by a drive motor and a high gravity field is the result of a centrifugal force field generated by rotation of the rotating packed bed 100. With the centrifugal force generated by the rotation, the absorbent passing through the filler region in the rotating packed bed 100 is cut into smaller droplets and thinner films, and the absorbent is thereby provided with a greater surface area. Besides, the gas to be treated and the absorbent are in contact with each other by flowing in opposite directions. Therefore, the gas-liquid contact area and the contact efficiency can be greatly increased and the overflow phenomenon can be significantly mitigated by the rotating packed bed 100 under the high-speed rotation. Thus, the target component of the gas to be treated can be effectively absorbed by the absorbent in the rotating packed bed 100.

The packed bed 200 has an absorbent inlet 210, an absorbent outlet 220, a gas inlet 230 and a gas outlet 240. The flow patterns/directions of the absorbent and the gas to be treated in the packed bed 200 are provided below for illustration purposes, and are not construed as limiting the present invention. For example, the absorbent flows into the packed bed 200 from the absorbent inlet 210 at the top of the packed bed 200, and flows out of the packed bed 200 from the absorbent outlet 220 at the bottom of the packed bed 200. The gas to be treated flows into the packed bed 200 from the gas inlet 230 at the bottom of the packed bed 200, and flows out of the packed bed 200 from the gas outlet 240 at the top of the packed bed 200. By such manner, the flow direction of the absorbent is opposite to the flow direction of the gas to be treated. The gas to be treated and the absorbent are in contact with each other in the filler region of the packed bed 200 by flowing in opposite directions, so the gas-liquid contact area can be greatly increased between the gas to be treated and the absorbent, and the target component of the gas to be treated can be effectively absorbed by the absorbent in the packed bed 200.

The rotating packed bed 100 and the packed bed 200 are connected with each other as follows. The absorbent outlet 120 is in connection with the absorbent inlet 210 to form an absorbent flow path that sequentially passes through the rotating packed bed 100 and the packed bed 200. Specifically, the absorbent flow path sequentially passes through the absorbent inlet 110, the absorbent outlet 120, the absorbent inlet 210 and the absorbent outlet 220. The gas outlet 240 is in connection with the gas inlet 130 to form a gas flow path that sequentially passes through the packed bed 200 and the rotating packed bed 100. Specifically, the gas flow path sequentially passes through the gas inlet 230, the gas outlet 240, the gas inlet 130 and the gas outlet 140.

The rotating packed bed 100 and the packed bed 200 are connected in a manner such that the absorbent can sequentially pass through the rotating packed bed 100 and the packed bed 200, and the gas to be treated can sequentially pass through the packed bed 200 and the rotating packed bed 100. Accordingly, the capturing efficiency of the target component is significantly improved, the volume of the capturing apparatus 10 is greatly decreased, and the energy consumption for capturing the target component is effectively reduced. Therefore, the equipment cost and energy cost are accordingly saved.

The capturing apparatus 10 can further include at least one of an absorbent pipeline system 300, a gas pipeline system 400, an absorbent supply apparatus 500, a gas source 600, an absorbent regenerating apparatus 700 and a target component purification apparatus 800.

The absorbent pipeline system 300 can include an absorbent pipeline 300a. The absorbent outlet 120 is in connection with the absorbent inlet 210 via the absorbent pipeline 300a of the absorbent pipeline system 300. The absorbent pipeline system 300 can optionally include at least one of absorbent pipelines 300b, 300c and 300d. The absorbent supply apparatus 500 is in connection with the rotating packed bed 100 via the absorbent pipeline 300b. The packed bed 200 is in connection with the absorbent regenerating apparatus 700 via the absorbent pipeline 300c. The regenerated absorbent can be drained from the absorbent regenerating apparatus 700 via the absorbent pipeline 300d.

The gas pipeline system 400 can include a gas pipeline 400a. The gas outlet 240 is in connection with the gas inlet 130 via the gas pipeline 400a of the gas pipeline system 400. The gas pipeline system 400 can optionally include at least one of gas pipelines 400b and 400c. The gas source 600 is in connection with the packed bed 200 via the gas pipeline 400b. The gas that has been treated by the absorbent is drained from the rotating packed bed 100 and transferred to the atmosphere via the gas pipeline 400c or is in connection with the subsequent gas processor or gas treatment machine via the gas pipeline 400c.

The absorbent supply apparatus 500 is in connection with the absorbent inlet 110 via the absorbent pipeline 300b and is configured to supply an absorbent to the rotating packed bed 100. The absorbent can be monoethanolamine (MEA), piperazine anhydrous (PZ), 2-(diethylamino)ethanol (DEEA) or a combination thereof, for example. The absorbent has a concentration of 10 wt % to 30 wt %, for example. However, the species and concentration of the absorbent are not limited by the present invention. People having ordinary skill in the art can select the proper species, recipe or concentration of the absorbent depending on the target component to be captured or the process requirements.

The gas source 600 is in connection with the gas inlet 230 via the gas pipeline 400b and is configured to supply a gas to be treated to the packed bed 200. The gas source 600 can be factories such as power plants, steel mills or oil refineries, for example. The gas to be treated can be a flue gas from factories, and the gas to be treated includes a target component such as carbon dioxide or the like, for example.

The absorbent regenerating apparatus 700 is configured to remove at least a portion of the target component captured by the absorbent, so the target component is released from the absorbent, and the absorbent is therefore regenerated. The absorbent regenerating apparatus 700 can be a stripper, for example. The absorbent regenerating apparatus 700 has an absorbent inlet 710 and an absorbent outlet 720. The absorbent inlet 710 is in connection with the absorbent outlet 220 via the absorbent pipeline 300c, so that the absorbent captured with the target component flows from the packed bed 200 to the absorbent regenerating apparatus 700. The absorbent pipeline 300d is in connection with the absorbent outlet 720, so as to re-transfer the absorbent into the rotating packed bed 100 and/or the absorbent supply apparatus 500; that is, the absorbent is recycled and used again.

The target component purification apparatus 800 is in connection with the absorbent regenerating apparatus 700 via a target component pipeline 900, so as to transfer the target component released from the absorbent into the target component purification apparatus 800 for purifying the target component. The target component that has been purified is optionally subjected to the subsequent treatment such as compression, storage, transportation or reuse.

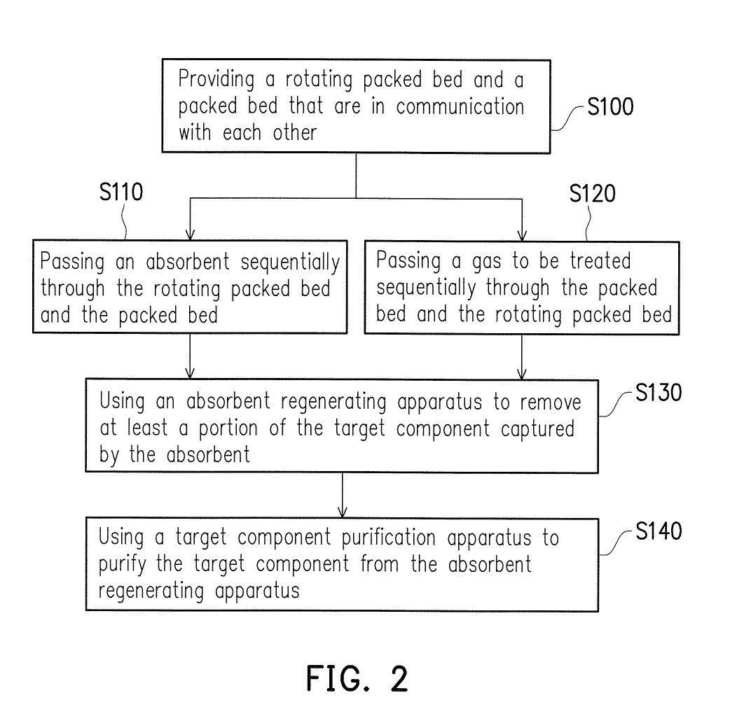

FIG. 2 is a process flow of capturing a target component from a gas according to an embodiment of the present invention. The method for capturing a target component from a gas is illustrated below with the capturing apparatus 10 shown in FIG. 1 and the process flow of FIG. 2. The connection relationship, property and function of each element in the capturing apparatus 10 have been described above, and the details are not iterated herein.

A step S100 is implemented, in which a rotating packed bed 100 and a packed bed 200 that are in connection with each other are provided. The rotating packed bed 100 and the packed bed 200 are connected in a manner such that an absorbent flow path sequentially passes through the rotating packed bed 100 and the packed bed 200, and a gas flow path sequentially passes through the packed bed 200 and the rotating packed bed 100.

A step S110 is implemented, in which an absorbent is allowed to sequentially pass through the rotating packed bed 100 and the packed bed 200. For example, the absorbent supplied by an absorbent supply apparatus 500 sequentially passes through the rotating packed bed 100 and the packed bed 200 via an absorbent pipeline 300b, an absorbent inlet 110, an absorbent outlet 120, an absorbent pipeline 300a, an absorbent inlet 210 and an absorbent outlet 220. The absorbent can be monoethanolamine (MEA), piperazine anhydrous (PZ), 2-(diethylamino)ethanol (DEEA) or a combination thereof, for example. The absorbent has a concentration of 10 wt % to 30 wt %, for example.

A step S120 is implemented, in which a gas to be treated is allowed to sequentially pass through the packed bed 200 and the rotating packed bed 100. For example, the gas to be treated supplied by a gas source 600 sequentially passes through the packed bed 200 and the rotating packed bed 100 via a gas pipeline 400b, a gas inlet 230, a gas outlet 240, a gas pipeline 400a, a gas inlet 130 and a gas outlet 140. The gas to be treated can be a flue gas from factories, and the gas to be treated includes a target component such as carbon dioxide or the like.

The absorbent and the gas to be treated are in contact with each other in the rotating packed bed 100 and in the packed bed 200, and a target component of the gas to be treated is captured by the absorbent. The gas-liquid contact area between the absorbent and the gas to be treated can be increased and therefore the capturing efficiency of the target component can be greatly increased by the rotating packed bed 100 and the packed bed 200. The rotating packed bed 100 can be a high-gravity rotating packed bed, for example. In an embodiment, the rotating packed bed 100 has a rotating speed of about 100 rpm to 3,000 rpm. In another embodiment, the rotating packed bed 100 has a rotating speed of about 700 rpm to 1,600 rpm.

A step S130 is optionally implemented, in which an absorbent regenerating apparatus 700 is used to remove at least a portion of the target component captured by the absorbent, and the absorbent is thereby regenerated. The absorbent regenerating apparatus 700 can be a stripper, for example.

A step S140 is optionally implemented, in which a target component purification apparatus 800 is used to purify the target component from the absorbent regenerating apparatus 700.

In view of the above embodiments, in the capturing apparatus 10 and the capturing method, the rotating packed bed 100 and the packed bed 200 are used in combination in which an absorbent sequentially passes through the rotating packed bed 100 and the packed bed 200, and a gas to be treated sequentially passes through the packed bed 200 and the rotating packed bed 100. In the case that the same gas capturing rate of the target component is reached, as compared to a conventional capturing apparatus using a packed bed alone and a conventional capturing apparatus using a rotating packed bed alone, the capturing apparatus 10 of this embodiment is provided with a smaller volume, so the equipment cost is therefore saved. Besides, in the case that the same gas capturing rate of the target component is reached, as compared to a conventional capturing apparatus using a packed bed alone and a conventional capturing apparatus using a rotating packed bed alone, the capturing apparatus 10 and the capturing method of this embodiment consume less energy. Therefore, in the capturing apparatus 10 and the capturing method of this embodiment, the object of reducing the equipment cost and the energy consumption can be easily achieved without loss of the gas capturing rate of the target component.

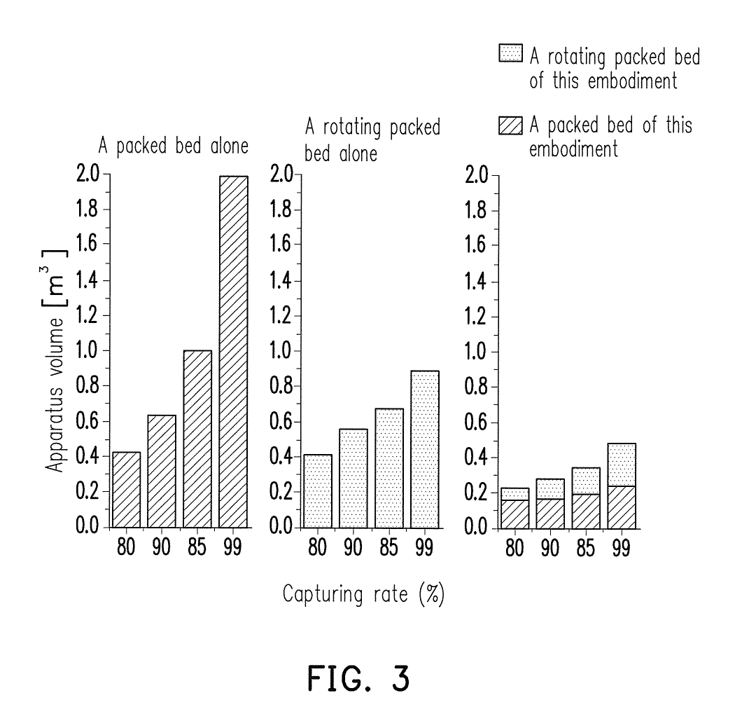

FIG. 3 is a volume comparison chart of a capturing apparatus using a rotating packed bed in combination with a packed bed according to an embodiment of the present invention, a conventional capturing apparatus using a packed bed alone, and another conventional capturing apparatus using a rotating packed bed alone.

In the examples of FIG. 3, carbon dioxide is taken as a target component to be captured for experiment. A rotating packed bed and a packed bed are used in combination in the capturing apparatus (e.g., capturing apparatus 10) of this embodiment. As shown in the results of FIG. 3, under the same gas treatment amount and the same capturing rate of carbon dioxide, as compared to the volume of a capturing apparatus using a packed bed alone, the total volume of the capturing apparatus of this embodiment that includes a rotating packed bed and a packed bed is reduced by about 47.6% to 75.4%. Besides, as compared to the volume of another capturing apparatus using a rotating packed bed alone, the total volume of the capturing apparatus of this embodiment that includes a rotating packed bed and a packed bed is reduced by about 44.9% to 49.1%. In view of the above, in this embodiment, a capturing apparatus designed with a rotating packed bed and a packed bed used in combination can effectively reduce the volume of the capturing apparatus and the equipment cost.

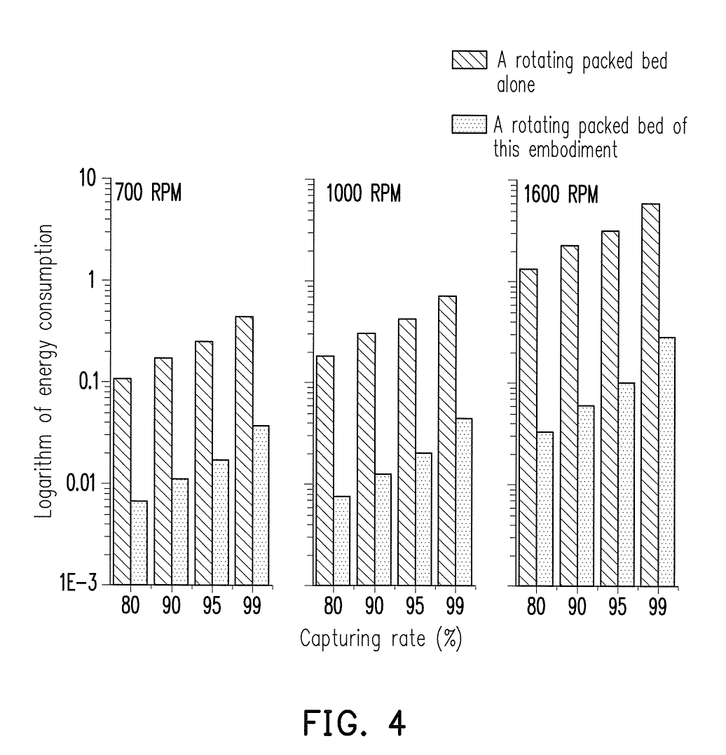

FIG. 4 is an energy consumption comparison chart of a capturing apparatus using a rotating packed bed in combination with a packed bed according to an embodiment of the present invention and a conventional capturing apparatus using a rotating packed bed alone.

In the examples of FIG. 4, carbon dioxide is taken as a target component to be captured for experiment. A rotating packed bed and a packed bed are used in combination in the capturing apparatus (e.g., capturing apparatus 10) of this embodiment. The energy is not consumed when carbon dioxide is captured by a packed bed, so the capturing apparatuses are compared in terms of the energy consumption for a rotating packed bed thereof. As shown in the results of FIG. 4, under the same gas treatment amount and the same capturing rate of carbon dioxide, the energy consumed by the capturing apparatus of this embodiment that includes a rotating packed bed and a packed bed is about 1/120 to 1/10 of the energy consumed by the capturing apparatus using a rotating packed bed alone. The reason is that in the capturing apparatus of this embodiment, the volume and outer radius of a rotating packed bed are reduced, and the energy consumption during rotation is proportional to the outer radius. Accordingly, the capturing apparatus of this embodiment using a rotating packed bed in combination with a packed bed can greatly reduce the energy consumption.

In summary, the above embodiments provide an apparatus and a method for capturing a target component from a gas, in which an absorbent sequentially passes through a rotating packed bed and a packed bed, and a gas to be treated sequentially passes through the packed bed and the rotating packed bed. By such configuration, the volume of the capturing apparatus is greatly decreased, and the energy consumption for capturing the target component is effectively reduced. Therefore, the equipment cost and energy cost are accordingly saved.

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

What is claimed is:

1. An apparatus for capturing a target component from a gas, comprising:
a rotating packed bed, having a first absorbent inlet, a first absorbent outlet, a first gas inlet and a first gas outlet; and
a packed bed, having a second absorbent inlet, a second absorbent outlet, a second gas inlet and a second gas outlet,
wherein the first absorbent outlet is in connection with the second absorbent inlet to form an absorbent flow path that sequentially passes through the rotating packed bed and the packed bed, and
the second gas outlet is in connection with the first gas inlet to form a gas flow path that sequentially passes through the packed bed and the rotating packed bed.

2. The apparatus of claim 1, further comprising an absorbent pipeline system, wherein the first absorbent outlet is in connection with the second absorbent inlet via the absorbent pipeline system.

3. The apparatus of claim 1, further comprising a gas pipeline system, wherein the second gas outlet is in connection with the first gas inlet via the gas pipeline system.

4. The apparatus of claim 1, further comprising an absorbent supply apparatus in connection with the first absorbent inlet and configured to supply an absorbent to the rotating packed bed.

5. The apparatus of claim 1, further comprising a gas source in connection with the second gas inlet and configured to supply a gas to be treated to the packed bed.

6. The apparatus of claim 1, further comprising an absorbent regenerating apparatus having a third absorbent inlet and a third absorbent outlet, wherein the third absorbent inlet is in connection with the second absorbent outlet.

7. The apparatus of claim 6, wherein the absorbent regenerating apparatus comprises a stripper.

8. The apparatus of claim 6, further comprising a target component purification apparatus in connection with the absorbent regenerating apparatus.

9. The apparatus of claim 1, wherein the rotating packed bed comprises a high-gravity rotating packed bed.

10. The apparatus of claim 1, wherein a rotating speed of the rotating packed bed is 100 rpm to 3,000 rpm.

11. The apparatus of claim 10, wherein the rotating speed of the rotating packed bed is 700 rpm to 1,600 rpm.

12. The apparatus of claim 1, wherein the target component comprises carbon dioxide.

13. A method for capturing a target component from a gas, comprising:
providing a rotating packed bed and a packed bed that are in connection with each other;
passing an absorbent sequentially through the rotating packed bed and the packed bed;
passing a gas to be treated sequentially through the packed bed and the rotating packed bed; and
contacting the absorbent and the gas to be treated in the rotating packed bed and in the packed bed, so that a target component of the gas to be treated is captured by the absorbent.

14. The method of claim 13, further comprising using an absorbent regenerating apparatus to remove at least a portion of the target component captured by the absorbent.

15. The method of claim 14, further comprising using a target component purification apparatus to purify the target component from the absorbent regenerating apparatus.

16. The method of claim 13, wherein a rotating speed of the rotating packed bed is 100 rpm to 3,000 rpm.

17. The method of claim 16, wherein the rotating speed of the rotating packed bed is 700 rpm to 1,600 rpm.

18. The method of claim 13, wherein the target component comprises carbon dioxide.

19. The method of claim 13, wherein the absorbent comprises monoethanolamine, piperazine anhydrous, 2-(diethylamino)ethanol or a combination thereof.

20. The method of claim 13, wherein a concentration of the absorbent is 10 wt % to 30 wt %.
